(19) United States
(12) Patent Application Publication
(10) Pub. No.: US 2011/0187617 A1
(43) Pub. Date: Aug. 4, 2011

(54) Transmission/Reception element

(75) Inventors: Akira Akiba, Kanagawa (JP); Koichi Ikeda, Kanagawa (JP)

(73) Assignee: Sony Corporation, Tokyo (JP)

(21) Appl. No.: 12/929,273

(22) Filed: Jan. 12, 2011

(30) Foreign Application Priority Data
Feb. 1, 2010 (JP) 2010-020371

(51) Int. Cl. H01Q 9/00

(52) U.S. Cl. 343/749

(57) ABSTRACT

A transmission/reception element includes: a plurality of metal layers each disposed with space from another; and a switch for controlling electrical coupling between the metal layers. The switch includes a contact-point group including a plurality of contact-point pairs each disposed in parallel between each two of the metal layers, and a drive section mechanically driving the contact-point group for state change of each of the contact-point pairs between in-contact and no-contact.

### BACKGROUND OF THE INVENTION

1. Field of the Invention

The present invention relates to a transmission/reception element suitable for use as an antenna with which the frequency characteristics can be changed with switch control.

2. Description of the Related Art

In recent years, a transmission/reception circuit is expected to cover a wider range of frequencies and to be ready for diversity and beamforming. Such an expectation thus leads to the increase of the number of antennas for a parallel arrangement. However, since the antenna is a component large in size occupying a large part of the area in the transmission/reception circuit, a larger number of antennas mean a much larger circuit area, and this is not considered desirable. To solve such a problem, an antenna called reconfigurable antenna has been under development. This reconfigurable antenna is provided with a plurality of metal patterns on a dielectric layer each for use as a radiation section (emission/propagation section), for example. These metal patterns are controlled in terms of their electrical coupling by a switch so that the radiation sections can be changed in electrical length.

Such a reconfigurable antenna mainly includes two types, one is the type with which the frequency (radiation frequency) can be controlled through arbitrary switching, and the other is the type with which the antenna directivity can be arbitrarily controlled. The antenna of the type with which the frequency is controlled through switching is described in US2009-0207091, for example, and such an antenna radiates electromagnetic waves at the frequency corresponding to the electrical length of the radiation sections. Generally, antennas radiate electromagnetic waves of frequencies being integral multiples of the base frequency (ω), i.e., ω, 2ω, 3ω, and others, with any one specific electrical length. On the other hand, as is capable of changing the electrical length through switch control, the reconfigurable antenna singly can transmit and receive electromagnetic waves of any frequencies not being integral multiples of each other. This accordingly helps to reduce the size of space needed for placement of antenna.

As an example, “Reconfigurable Antenna Implementation in Multi-radio Platform”, Helen K. Pan, et al. (Intel Corporation, University of Illinois at Urbana-Champaign) describes a reconfigurable antenna being a monopole antenna partially provided with a MOSFET (Metal Oxide Semiconductor Field-Effect Transistor) switch. This reconfigurable antenna can be changed in state in response to a control signal coming from the outside, i.e., can be changed between a state 1 (at the frequencies of 0.8 GHz, 0.9 GHz, and 2.4 GHz), and a state 2 (at the frequencies of 1.8 GHz, 1.9 GHz, 2.1 GHz, and 5.0 GHz). Herein, in the state 1, the frequencies of 0.8 GHz and 0.9 GHz are not integral multiples of each other. This is because the reconfigurable antenna is designed to have a wide range of resonance frequencies, and any close frequencies are covered by one resonance frequency.

### SUMMARY OF THE INVENTION

The issue here is that with the reconfigurable antenna as described above, each of the metal patterns is provided so as to have space with another for placement purpose of a switch. Such spaces resultantly cause a problem of narrowing the band with radiation characteristics when the metal patterns become conducting, and the resulting patterns of radiation are distorted. There is another problem of decreasing the antenna directivity due to the radiation of electromagnetic waves from a drive circuit including wiring patterns for switch control use. For not causing such problems, there may be a design idea of placing the switches themselves outside of the metal patterns, but this configuration does not yet solve the problem of influence to be exerted by the spaces between the metal patterns as described above. Considering the fact that the antenna directivity is decreased if the switches are placed far too off, the switches may be each disposed in proximity to each end of the corresponding space portion. This configuration, however, does not yet solve the problem of influence by the spaces between the metal patterns described above, and further, the drive circuit for the switches is increased in number.

It is thus desirable to provide a transmission/reception element that is capable of frequency switching among a plurality of patterns while being able to retain satisfactorily the radiation characteristics.

A transmission/reception element in an aspect of the invention is provided with a plurality of metal layers each disposed with space from another, and a switch for controlling these metal layers in terms of their electrical coupling. The switch is provided with a contact-point group, and a drive section. The contact-point group includes a plurality of contact-point pairs each disposed in parallel between each two of the corresponding metal layers. The drive section mechanically drives the contact-point group for changing each of the contact-point pairs in state between in-contact and no-contact.

With the transmission/reception element in the aspect of the invention, when the drive section in the switch starts driving the contact-point group, the contact-point pairs are each changed in state between in-contact and no-contact so that the metal layers are controlled in terms of their electrical coupling. With the switch control as such, over the entire metal layers all being conducting, radio waves are transmitted/received at the frequency corresponding to the electrical length of the metal layers. Herein, by mechanically driving the contact-point group as such, the drive circuits can be each disposed with space from the corresponding metal layer so that any possible influence to be exerted by electromagnetic waves coming from the drive circuits is suppressed. Moreover, when the metal layers are each disposed with a physical space from another, any desired level of radiation characteristics are indeed difficult to obtain, but such physical spaces between the metal layers are reduced in size with the configuration that each of a plurality of contact-point pairs is disposed in parallel in the contact-point group.

According to the transmission/reception element in an aspect of the invention, in a switch of controlling a plurality of metal layers in terms of their electrical coupling, a drive section mechanically drives a contact-point group, and therefore the radiation of electromagnetic waves coming from a drive circuit may be suppressed. Also with the configuration that a plurality of contact-point pairs are each disposed in parallel in the contact-point group, the physical spaces between the metal layers can be reduced in size so that any desired level of radiation characteristics can be obtained with more ease. Accordingly, with the radiation characteristics satisfactorily retained, frequency switching can be performed among a plurality of patterns.

### BRIEF DESCRIPTION OF THE DRAWINGS

FIG. 1 is a plan view of a reconfigurable antenna in a first embodiment of the invention, showing the schematic configuration thereof;

FIG. 2 is a cross sectional view of the reconfigurable antenna of FIG. 1 taken along a line I-I;

FIGS. 3A and 3B are each a plan view of the reconfiguration antenna of FIG. 1, showing the configuration of a portion in proximity to a region II, and specifically, FIG. 3A shows the reconfigurable antenna in an open state, and FIG. 3B shows it in a close state;

FIGS. 4A and 4B are schematic diagrams for illustrating the operation effects of the reconfigurable antenna of FIG. 1;

FIGS. 5A and 5B are schematic diagrams of reconfigurable antennas in comparison examples 1 and 2, respectably, showing their schematic configurations;

FIG. 6 is a schematic diagram for illustrating the radiation characteristics of the reconfigurable antenna of FIG. 1;

FIG. 7 is a characteristics diagram showing the relationship between the frequency and the reflection intensity in an example 1;

FIG. 8 is a plan view of a reconfigurable antenna of a modified example 1, showing the schematic configuration thereof;

FIGS. 9A to 9C are schematic diagrams for illustrating the operation effects of the reconfigurable antenna of FIG. 8;

FIG. 10 is a plan view of a reconfigurable antenna in a second embodiment of the invention, showing the schematic configuration thereof;

FIGS. 11A to 11C are schematic diagrams for illustrating the operation effects of the reconfigurable antenna of FIG. 10;

FIG. 12 is a plan view of a reconfigurable antenna in a third embodiment of the invention, showing the schematic configuration thereof;

FIG. 13A to 13C are schematic diagrams for illustrating the operation effects of the reconfigurable antenna of FIG. 12;

FIG. 14 is a plan view of a reconfigurable antenna in a fourth embodiment of the invention, showing the schematic configuration thereof;

FIGS. 15A and 15B are each a schematic diagram for illustrating the operation effects of the reconfigurable antenna of FIG. 14;

FIG. 16 is a characteristics diagram showing the relationship between the frequency and the reflection intensity in an example 2,

FIG. 17 is a plan view of a reconfigurable antenna of a comparison example 3, showing the schematic configuration thereof;

FIG. 18 is a plan view of a reconfigurable antenna of a modified example 2, showing the schematic configuration thereof;

FIGS. 19A to 19C are schematic diagrams for illustrating the operation effects of the reconfigurable antenna of FIG. 18;

FIG. 20 is a plan view of a reconfigurable antenna in a fifth embodiment of the invention, showing the schematic configuration thereof; and

FIGS. 21A to 21C are schematic diagrams for illustrating the operation effects of the reconfigurable antenna of FIG. 20.

### DETAILED DESCRIPTION OF THE PREFERRED EMBODIMENTS

In the below, embodiments of the invention are described in detail by referring to the accompanying drawings. Note that the description is given in the following order.

1. First Embodiment (exemplary reconfigurable antenna in which metal patterns are disposed in series)

2. Modified Example 1 (another example of the first embodiment)

3. Second Embodiment (exemplary reconfigurable antenna in which metal patterns are disposed two-dimensionally)

4. Third Embodiment (exemplary monopole antenna)

5. Fourth Embodiment (exemplary bowtie antenna)

6. Modified Example 2 (another example of the fourth embodiment)

7. Fifth Embodiment (exemplary reconfigurable antenna in which triangle-shaped metal patterns are disposed two-dimensionally)

8. Application Example (exemplary electronic device using a transmission/reception element)

### First Embodiment

### Configuration of Reconfigurable Antenna 1

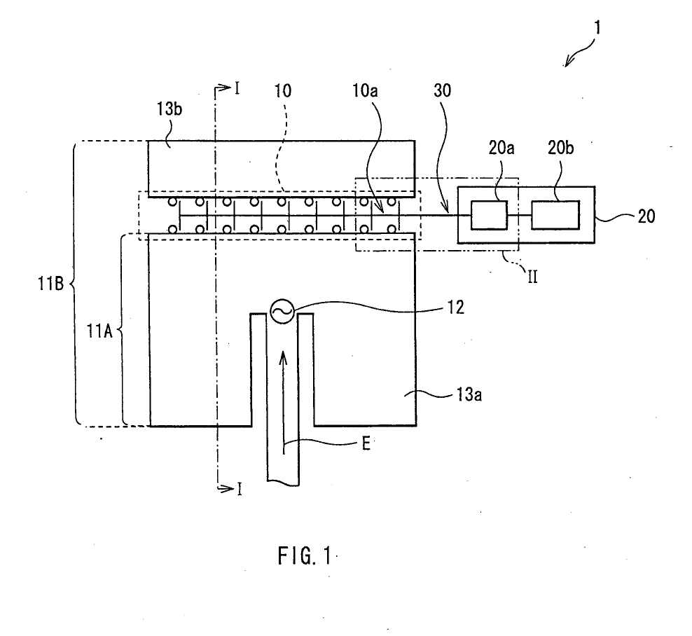

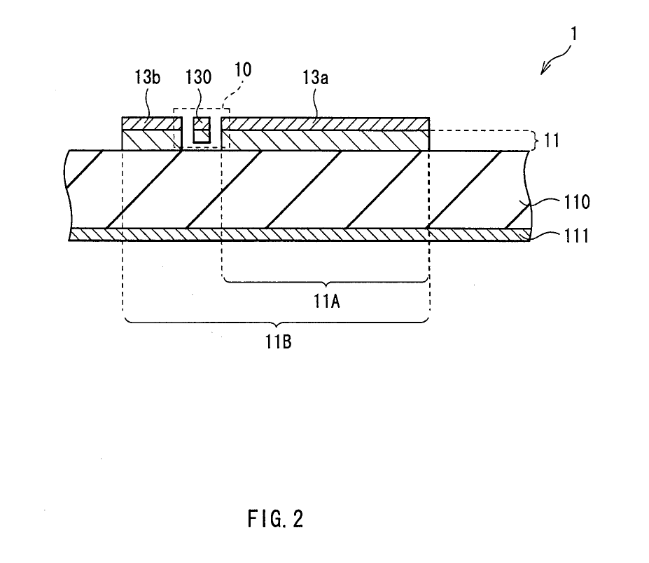

FIG. 1 is a diagram showing the schematic configuration of a reconfigurable antenna 1 in a first embodiment of the invention. FIG. 2 is a cross sectional view of the reconfigurable antenna 1 of FIG. 1 taken along a line I-I. Such a reconfigurable antenna 1 is a patch antenna (microstrip antenna) that is capable of frequency switching among a plurality of patterns through switch control. Such a reconfigurable antenna 1 includes two metal patterns 13a and 13b, which are disposed with space from each other in a predetermined region on the surface of a dielectric layer 110, for example. One of the two metal patterns, e.g., the metal pattern 13a in this example, is provided with a feeding point 12 for a supply of current (voltage) along a feeding direction E. To the space between the metal patterns 13a and 13b, a contact-point group 10 is provided, and this contact-point group 10 is being coupled with a drive section 20 via a push rod 30. This drive section 20 drives the contact-point group 10. These components, i.e., the contact-point group 10, the drive section 20, and the push rod 30, all function as a switch for controlling the metal patterns 13a and 13b in terms of electrical coupling therebetween. A ground layer 111 is formed on the undersurface of the dielectric layer, and is grounded.

A substrate 11 is a dielectric substrate configured by a silicon (Si) substrate covered on the surface by an insulation film made of silicon nitride (SiN), silicon oxide (SiO₂), or others, for example.

The metal patterns 13a and 13b each function as a radiation section (emission and propagation section) in the reconfigurable antenna 1, and each include a metal film made of gold (Au), aluminum (Al), copper (Cu), and others. This metal film and the substrate 11 may sandwich therebetween a thin film made of titanium (Ti), chromium (Cr), tungsten (W), and others for use as a close-contact layer. Alternatively, the metal patterns 13a and 13b may include precious metal such as platinum (Pt), ruthenium (Ru), and rhodium (Rh). In this embodiment, these metal patterns 13a and 13b are each shaped like a rectangle in the planar view, for example, and are disposed in series along the feeding direction E to oppose each other on one side. In this example, similarly to a movable contact point 14a and a fixed contact point 14b that will be described later, the metal patterns 13a and 13b are each also a lamination film including a film made of gold formed on a film made of titanium.

Such metal patterns 13a and 13b are electrically insulated from each other by being placed with space from each other on the dielectric layer 110, and are controlled in terms of electrical coupling therebetween by switching of the contact-point group 10 between open operation (OFF operation) and close operation (ON operation). Such switching will be described later in detail. To be specific, when the metal patterns 13a and 13b are electrically insulated from each other, only the metal pattern 13a serves as a radiation section, i.e., radiation section 11A. When the metal patterns 13a and 13b are electrically conducting, the whole region across the metal patterns, i.e., region from the metal pattern 13a to the metal pattern 13b, serves as a radiation section, i.e., radiation section 11B.

The contact-point group 10 includes a plurality of contact-point pairs 10a, each of which is arranged in parallel. As an example, these contact-point pairs 10a are arranged along the opposing sides of the metal patterns 13a and 13b almost entirely across the space therebetween. The contact-point group 10 is disposed on one end side of the push rod 30 extending in the direction along which the contact-point pairs 10a are arranged.

The drive section 20 is configured to include an actuator 20a, and a drive circuit 20b that drives the actuator 20a. As the actuator 20a, suitably used is a MEMS (Micro-Electro-Mechanical Systems) actuator made by the MEMS technology, for example, and especially an electrostatic actuator operated by lateral driving.

The push rod 30 is coupled to the drive section 20 on one end, and, a part of the contact-point group specifically, contact-point bars 30a and the movable contact points 14a that will be described later is provided on the other end side.

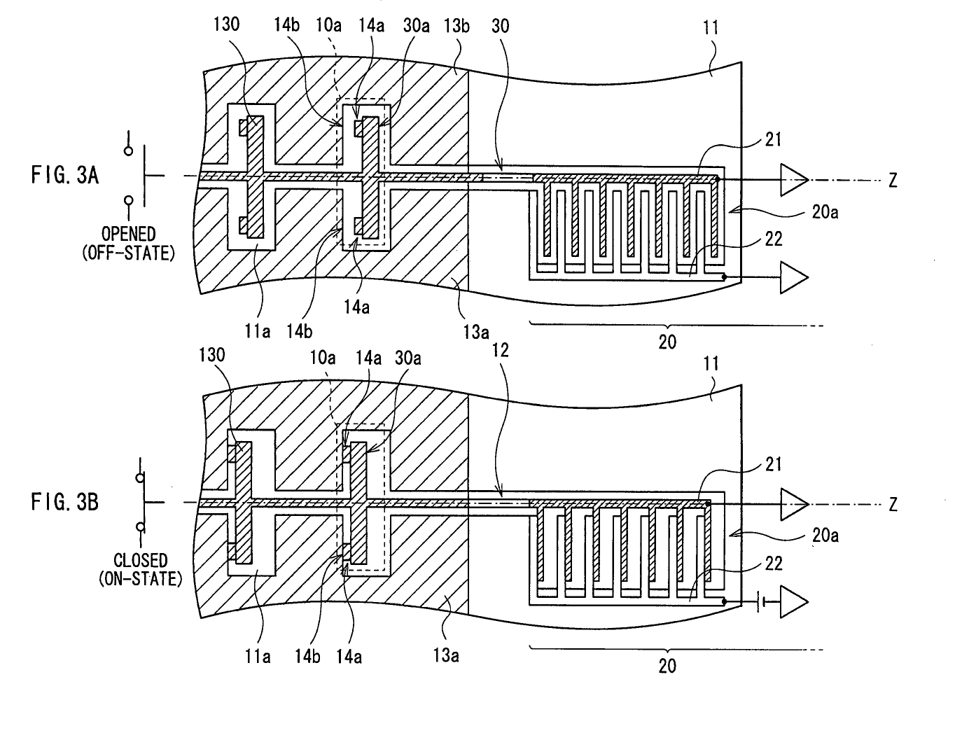

By referring to FIGS. 3A and 3B, a description is given about the specific configurations of those components, i.e., the contact-point group 10 (the contact-point pairs 10a), the drive section 20, and the push rod 30. FIGS. 3A and 3B are each a diagram showing a portion in proximity to a region II of FIG. 1, i.e., the portion in proximity to the border between the contact-point group 10 and the metal patterns 13a and 13b, and the drive section 20. Specifically, FIG. 3A shows the reconfigurable antenna in the OFF state, and FIG. 3B shows it in the ON state;

In this embodiment, the space between the metal patterns 13a and 13b is a cavity 11a housing therein the push rod 30 to be slidable. The push rod 30 is a rod-like member extending along the direction in which the contact-point pairs 10a are arranged, i.e., along an operation axis Z. The push rod is provided with a plurality of contact-point bars 30a each protruding in the direction orthogonal to the operation axis Z. The wall surface of the cavity 11a, i.e., the plane where the metal patterns 13a and 13b are opposing each other, is shaped with concavities and convexities to match with the shape of the push rod 30 and that of the corresponding contact-point bar 30a, i.e., shaped like comb teeth. The metal patterns 13a and 13b are disposed so as to sandwich the push rod 30 therebetween and the contact-point bars 30a to allow engagement between such a shape with concavities and convexities and each corresponding protruding contact-point bar 30a.

The push rod 30 and the contact-point bar 30a are each configured by a base covered by a metal film 130 on the surface. The base is configured similarly to the substrate 11, and the metal film 130 is made of a material similar to that of the movable contact point 14a and the fixed contact point 14b, for example. Note here that, in the push rod 30, the metal film 130 covers only portions corresponding to the metal patterns 13a and 13b, i.e., the radiation sections 11A and 11B.

To the wall surface of the cavity 11a, i.e., the surface shaped with concavities and convexities where the metal patterns 13a and 13b are opposing each other, a plurality of fixed contact points 14b are each disposed in parallel. The fixed contact points 14b are each being a part of the corresponding contact-point pair 10a. In the push rod 30, the contact-point bars 30a are each provided with the movable contact point 14a in such a manner as to oppose the corresponding fixed contact point 14b. These components, i.e., the contact-point bar 30a, the movable contact point 14a, and the fixed contact point 14b, are configuring one contact-point pair 10a. In such a contact-point pair 10a, in response to the sliding movement of the push rod 30, i.e., positional change thereof along the operation axis Z, the movable contact point 14a and the fixed contact point 14b are changed in state between in-contact (ON state) and no-contact (OFF state).

Such a cavity 11a can be formed by processing the substrate 11 using the MEMS technology including lithography and dry etching, for example. During the etching, the push rod 30 and the contact-point bar 30a are formed, i.e., extracted. After the substrate 11 is formed with the cavity 11a as such, the resulting substrate 11 may be formed with the metal patterns 13a and 13b on the surface, and the metal film 130 may be formed at a predetermined region of the contact-point bar 30a and that of the push rod 30.

The movable contact point 14a and the fixed contact point 14b are each a lamination film including a layer made of gold disposed on a layer made of titanium, for example. Such a lamination film can be formed by sputtering and photolithography, for example, and in the film, the titanium layer has the thickness of 0.1 μm, and the gold layer of 2.0 μm, for example.

In the drive section 20, such a cavity 11a as described above is formed to extend, and in this cavity 11a, the actuator 20a is disposed. That is, the actuator 20a is formed in the substrate 11 that is shared with the contact-point group 10, and is coupled to the push rod 30. Note here that a part of the push rod 30 located in the region in such a drive section 20 is not formed with the metal film 130, and from the part, the base made of a material same as that of the substrate 11 is exposed, for example. More in detail, such a part of the push rod 30 is the portion between the contact-point group 10, and the actuator 20a. That is, the drive section 20 is provided to the region outside of the radiation sections 11A and 11B, and the contact-point group 10 and the actuator 20a are electrically insulated from each other but are physically coupled together by the push rod 30. In the drive section 20, the drive circuit 20b of the actuator 20a is provided to the region beyond the actuator 20a, and is sufficiently away from the contact-point pair 10a and the metal patterns 13a and 13b.

The actuator 20a is configured to include a movable electrode 21, and a fixed electrode 22. The movable electrode 21 slides along the operation axis same as that of the push rod 30, i.e., operation axis Z, and the fixed electrode 22 is fixed to the substrate 11. This actuator 20a is a so-called electrostatic MEMS actuator operated by lateral driving, i.e., is operated to displace the movable electrode 21 along the operation axis Z by the electrostatic force.

The movable electrode 21 and the fixed electrode 22 are each a comb-teeth electrode, and are disposed so as to engage with each other. The movable electrode 21 and the fixed electrode 22 as such are formed as below, for example. That is, the substrate 11 is subjected to three-dimensional processing using the technologies of etching and lithography to form a base in the comb-teeth shape. The resulting base is covered on the surface with a metal film similarly to the movable contact point 14a and the fixed contact point 14b described above, i.e., lamination film including gold and titanium layers. The movable electrode 21 is coupled to the push rod 30 or is formed as a piece therewith, and the push rod 30 is configured to slide in response to the sliding movement of the movable electrode 21.

Note that, in this example, the actuator 20a is surely not restricted to such an electrostatic actuator, and any other types of actuators operated in another driving mode utilizing the MEMS capabilities are also applicable, e.g., piezoelectric actuator, electromagnetic actuator, and bimetallic actuator.

### (Operation Effects of Reconfigurable Antenna 1)

### (Operation Effects of Frequency Switching)

In this embodiment, as shown in FIG. 1, the two metal patterns 13a and 13b are disposed with the contact-point group 10 sandwiched therebetween, and the electrical coupling between these metal patterns 13a and 13b is controlled by switching of the contact-point group 10 between the OFF operation and the ON operation. To be specific, during the OFF operation, the metal patterns 13a and 13b are electrically insulated from each other, and electromagnetic waves come only from the metal pattern 13a including the feeding point 12, i.e., the radiation section 11A is put in operation. On the other hand, during the ON operation, the metal patterns 13a and 13b are electrically conducting, and electromagnetic waves come from these metal patterns 13a and 13b in their entirety across the area, i.e., the radiation section 11B is put in operation.

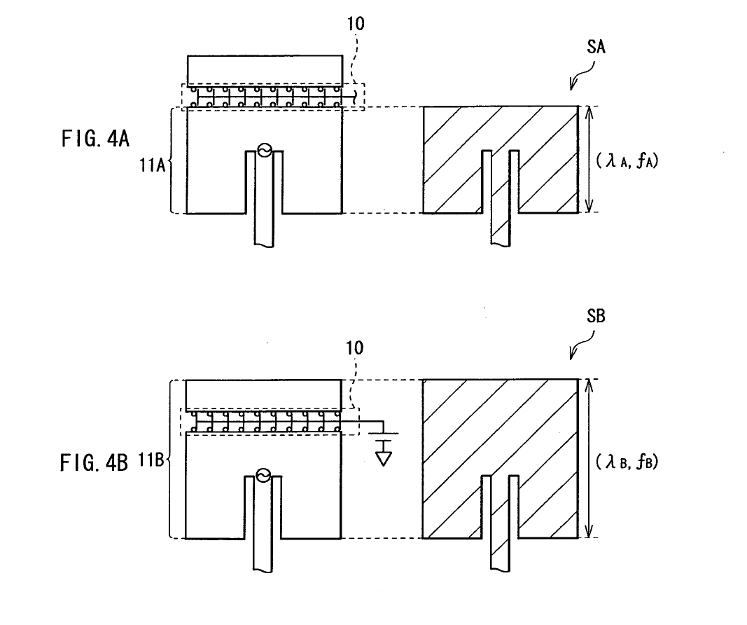

In such a reconfigurable antenna 1, the electromagnetic waves are radiated at the frequency corresponding to the electrical length of the radiation sections therein. As an example, as shown in FIG. 4A, during the OFF operation, the electromagnetic waves are radiated at a frequency f_{A} corresponding to an electrical length of the radiation section 11A. On the other hand, as shown in FIG. 4B, during the ON operation, the electromagnetic waves are radiated at a frequency f_{B} corresponding to an electrical length λ_{B} of the radiation section 11B. Assuming that the metal patterns 13a and 13b are formed on a printed circuit made of FR4 (Flame Retardant Type 4), for example, two frequencies (base frequencies) of f_{A}=60 GHz and f_{B}=50 GHz are obtained when λ_{A}=1.1, and λ_{B}=1.5.

The electromagnetic waves that can be radiated from the antenna are of the base frequency, and of a frequencies that are integral multiples of the base frequency. Accordingly, the electromagnetic waves that are to be radiated from the antenna in this embodiment are of the frequencies f_{A} and f_{B}, and frequencies that are integral multiples of the frequencies f_{A} and f_{B}, i.e., frequencies f_{A}, 2f_{A}, 3f_{A}, and others, and f_{B}, 2f_{B}, 3f_{B}, and others. In other words, through control by the contact-point group 10 over the electrical coupling between the two metal patterns 13a and 13b, the frequency switching can be performed based on two frequencies of f_{A} and f_{B}.

### (Operation Effects for Radiation Characteristics)

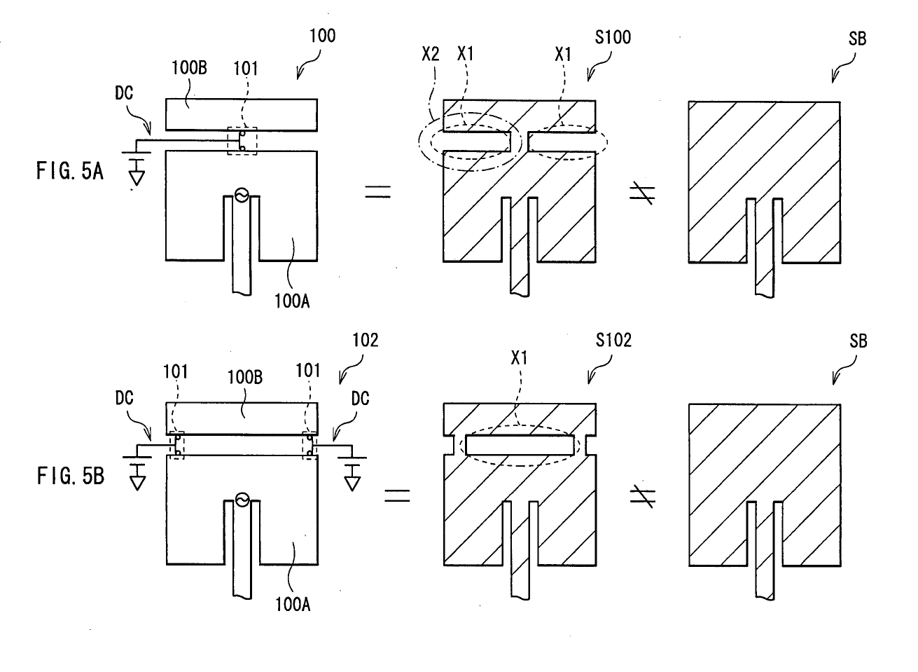

FIG. 5A shows a reconfigurable antenna 100 in a comparison example 1, and FIG. 5B shows a reconfigurable antenna 102 in a comparison example 2. These reconfigurable antennas 100 and 102 are those performing frequency switching using a switch 101 based on two frequencies by controlling the electrical coupling between two metal patterns 100A and 100B disposed with space therebetween.

The reconfigurable antenna 100 is configured to include the switch 101 only in the region in proximity to the center space between the metal patterns 100A and 100B. As such, in the reconfigurable antenna 100, the radiation surface (radiation surface S100) in the radiation section is formed with a large notch X1 when the metal patterns 100A and 100B are electrically conducting. The notch X1 formed as such causes a problem of narrowing the band of radiation characteristics, and the resulting patterns of radiation are distorted. Moreover, due to the configuration that the switch 101 is connected with a drive circuit DC for switch control use, the influence by radiation of electromagnetic waves X2 from the drive circuit DC resultantly decreases the antenna directivity. In other words, unlike any ideal radiation surface (radiation surface SB) when the metal patterns 100A and 100B are electrically conducting, the radiation surface S100 has difficulty in achieving the radiation characteristics of any desired level.

On the other hand, the reconfigurable antenna 102 is configured to include the switch 101 in proximity to each end of the space between the metal patterns 100A and 100B. As such, the switches 101 in the reconfigurable antenna 102 are located closer to the outside so that the drive circuit DC can be positioned away from the metal patterns 100A and 100B. This thus reduces the influence by radiation of the electromagnetic waves from the drive circuit DC as described above. The problem here is that, however, the notch X1 still exists on the radiation surface (radiation surface S102) in the radiation section when the metal patterns 100A and 100B are electrically conducting. In other words, unlike the radiation surface SB, the radiation surface S102 still has difficulty in achieving the radiation characteristics of any desired level.

On the other hand, in the embodiment, the metal patterns 13a and 13b are controlled in terms of electrical coupling therebetween by the drive section 20 mechanically driving the contact-point group 10. To be specific, using such an actuator 20a as shown in FIGS. 3A and 3B, a switch control operation is performed as below.

When receiving a command for the close operation, i.e., for switching to the ON state, when being in the OFF state with no voltage application, the drive section 20 applies a drive voltage between the movable electrode 21 and the fixed electrode 22 in the actuator 20a. In response thereto, an electromagnetic force is generated between the movable electrode 21 and the fixed electrode 22, and the movable electrode 21 slides along the operation axis Z to be close to the fixed electrode 22. In accordance therewith, the push rod 30 slides along the operation axis Z, and then comes in contact with the contact-point pairs 10d so that the state is changed to ON (FIG. 3B). On the other hand, when receiving a command for the open operation, i.e., for switching to the OFF state, when being in the ON state with a voltage application, the drive section 20 stops the voltage application between the movable electrode 21 and the fixed electrode 22. In response thereto, the magnetic force is not generated any more between the movable electrode 21 and the fixed electrode 22, and the movable electrode 21 slides along the operation axis Z as if to move away from the fixed electrode 22. In accordance therewith, the push rod 30 slides along the operation axis Z, then the contact with the contact-point pairs 10d is broken so that the push rod 30 is put back to the position of FIG. 3A. Note that, in the drive circuit 20b (not shown in FIGS. 3A and 3B), the actuator 20a is driven desirably with the movable electrode 21 being grounded, and with the fixed electrode 22 being at a control potential. This is because the push rod 30 can remain at the GND potential through the connection with the movable electrode 21.

As such, when the push rod 30 is driven by the actuator 20a, and when the push rod 30 is moved to slide (displaced) along the operation axis Z, in response to such a sliding movement, the contact-point pairs 10a in the contact-point group 10 are changed in state between in-contact and no-contact. By such a state change, the metal patterns 13a and 13b are controlled in terms of electrical coupling therebetween.

The driving force from the drive circuit 20a is converted into the mechanical motion in the actuator 20a, and this mechanical motion is transmitted to each of the contact-point pairs 10a via the push rod 30. In other words, the mechanical coupling will only do between the contact-point group 10 and the drive section 20, and the components in the layout can remain insulated from each other, thereby being able to reduce any possible influence by radiation of the electromagnetic waves coming from the drive circuit 20b including the switch control line and others.

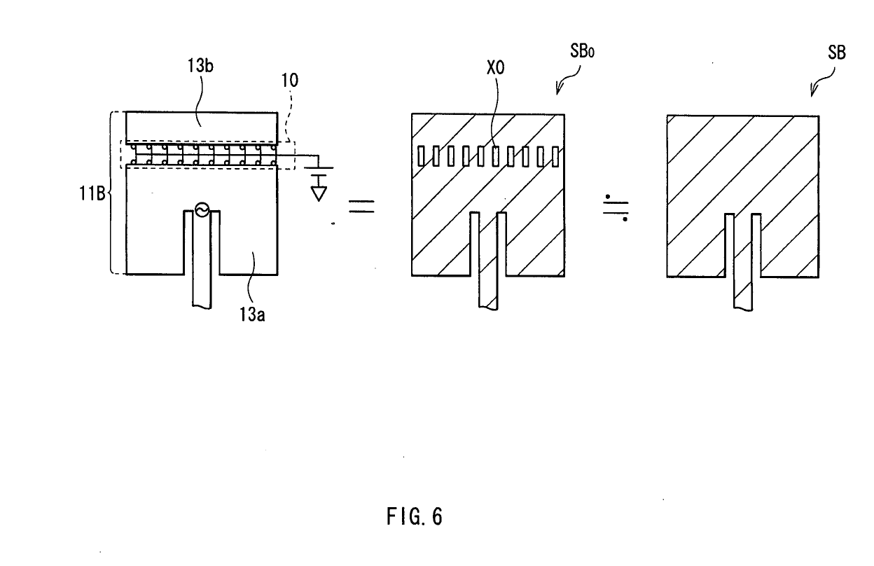

Also in the embodiment, a plurality of contact-point pairs 10a being the contact-point group 10 are each disposed in parallel between the metal patterns 13a and 13b. With such a configuration, as shown in FIG. 6, when the metal patterns 13a and 13b are electrically conducting, the radiation surface (radiation surface SB₀) in the radiation section 11B is formed with a plurality of notches X0 depending on the spacing between the contact-point pairs 10a. However, these notches X0 are each extremely small in size, and thus the resulting radiation surface SB₀ is approximately equivalent to the radiation surface SB. Moreover, such a plurality of contact-point pairs 10a can be collectively driven by a piece of drive section 20 so that, compared with a configuration of including the drive section to each of the contact-point pairs, the drive circuits and the control lines can be considerably reduced in number.

Furthermore, in this embodiment, as shown in FIGS. 3A and 3B, the wall surface of the cavity 11a, i.e., the plane where the metal patterns 13a and 13b are opposing each other, is shaped with concavities and convexities to match with the shape of the push rod 30 and that of the contact-point bar 30a, and the push rod 30 and the contact-point bar 30a are each covered on the surface by the metal film 130. With such a configuration, as shown in FIG. 6, the space between the metal patterns 13a and 13b is reduced in size to a further degree so that the notches X0 are also reduced in size on the radiation surface SB₀. As a result, the radiation surface SB₀ of the radiation section 11B is more analogous to the ideal radiation surface SB.

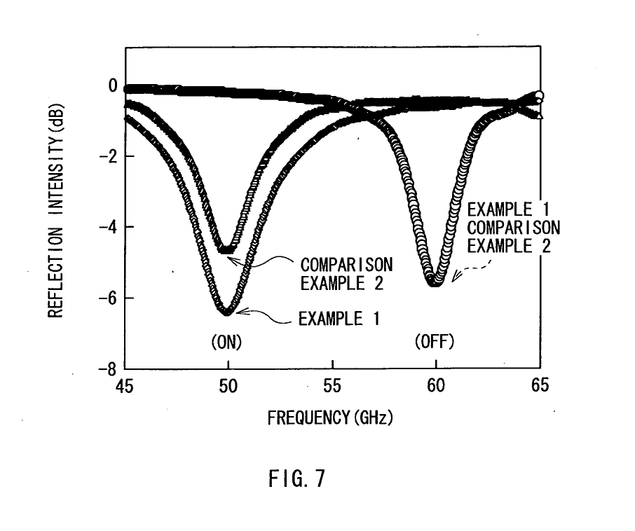

As an example of the first embodiment, i.e., example 1, the reflection intensity (dB) with respect to the frequency (GHz) of the reconfigurable antenna 1 is calculated using an electromagnetic simulator. FIG. 7 shows the calculation result. Note that the characteristics indicated by a broken arrow are those of the radiation section 11A (electrical length λ_{A}, and frequency f_{A}) when the metal patterns 13a and 13b are electrically insulated from each other, i.e., in the OFF state. The characteristics indicated by a solid arrow are those of the radiation section 11B (electrical length λ_{B}, and frequency f_{B}) when the metal patterns 13a and 13b are electrically conducting, i.e., in the ON state. In the OFF state, settings are made as λ_{A}=1.1, and λ_{B}=1.5 in the ON state. Also for the reconfigurable antenna 102 in the comparison example 2 described above, the reflection intensity with respect to the frequency is calculated similarly for use as a comparison example of this example 1.

With the calculation results in both of the example 1 and the comparison example 2, the resonance frequency is observed at 60 GHz in the OFF state (electrical length λ_{A}=1.1), and in the ON state (electrical length λ_{B}=1.5), the resonance occurs at 50 GHz. These results tell that both the example 1 and the comparison example 2 implement the reconfigurable antenna of including the two values of base frequency, i.e., 50 GHz and 60 GHz. Note here that, in the ON state, the reflection intensity in the example 1 shows the peak higher about by 2 dB than that in the comparison example 2. This indicates that the reconfigurable antenna in the example 1 has a higher gain and is excellent in directivity compared with the antenna in the comparison example 2. In other words, this tells that the radiation characteristics are to be improved with the configuration of including a plurality of contact-point pairs 10a each disposed in parallel, and by mechanically driving those contact-point pairs 10a.

As such, in the embodiment, the drive section 20 controls the metal patterns 13a and 13b in terms of electrical coupling therebetween by mechanically driving the contact-point group 10 so that the drive circuit 20b can be disposed away from the contact-point group 10. This configuration accordingly reduces any possible influence by electromagnetic waves coming from the drive circuit 20b. Moreover, the contact-point group 10 includes a plurality of contact-point pairs 10a each disposed in parallel so that the metal patterns 13a and 13b are reduced in physical space therebetween, and this favorably helps the resulting reconfigurable antenna to have any desired radiation characteristics. As such, the reconfigurable antenna in this embodiment can perform frequency switching among a plurality of patterns (frequency switching based on the base frequencies F_{A} and F_{B} in this example) while being able to retain satisfactorily the radiation characteristics.

### Modified Example 1

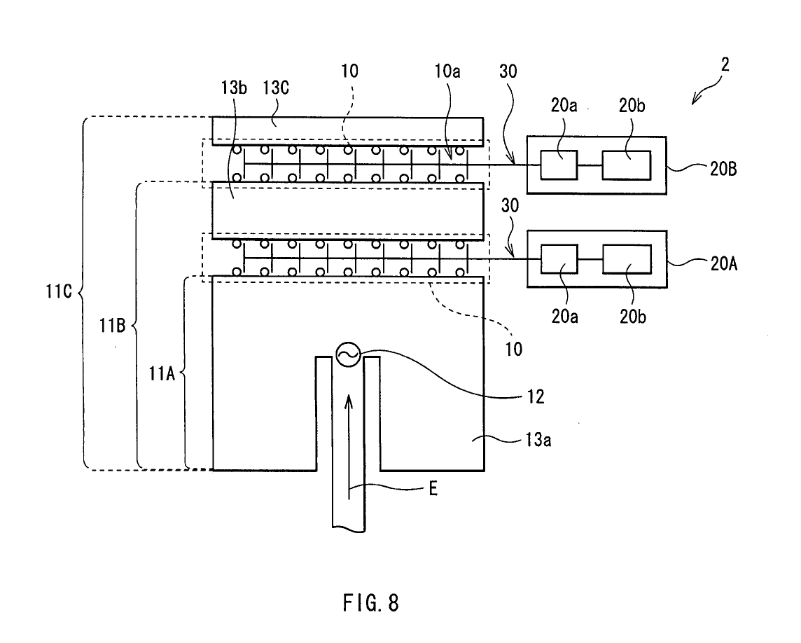

FIG. 8 is a diagram showing the schematic configuration of a reconfigurable antenna 2 in a modified example of the first embodiment described above. Similarly to the reconfigurable antenna 1 described above, this reconfigurable antenna 2 is a patch antenna in which a plurality of rectangular-shaped metal patterns are disposed in series along the feeding direction E via the contact-point groups 10. The contact-point groups 10 are respectively coupled with the drive sections 20A and 20B via the push rod 30, and are mechanically driven so that the contact-point pairs 10a therein are changed in state between in-contact and no-contact. Note that any component similar to that in the first embodiment described above is provided with the same reference numeral, and is not described again if appropriate.

However, unlike the reconfigurable antenna 1 described above, the reconfigurable antenna 2 in this modified example is provided with three metal patterns in total including a metal pattern 13c in addition to the metal patterns 13a and 13b, and the contact-point group 10 is provided between the metal patterns 13a and 13b, and between the metal patterns 13b and 13c. These contact-point groups 10 are respectively coupled with the drive sections 20A and 20B. Similarly to the drive section 20 described above, the drive sections 20A and 20B are each provided with the actuator 20a coupled to the corresponding push rod 30, and the drive circuit 20b for driving the actuator 20a.

These metal patterns 13a to 13c are electrically insulated from each other by being disposed with space from one another on the dielectric layer, but are controlled in terms of their electrical coupling by switching of the contact-point groups 10 between the open operation (OFF operation) and the close operation (ON operation) similarly to the first embodiment described above. Moreover, based on the state of electrical coupling between the metal patterns 13a and 13b, either of the radiation section 11A or 11B is activated. Note that, in this modified example, the metal patterns 13b and 13c are made to be electrically conducting to activate the region across the metal patterns, i.e., region from the metal pattern 13a to the metal pattern 13c, as another radiation section, i.e., radiation section 11C.

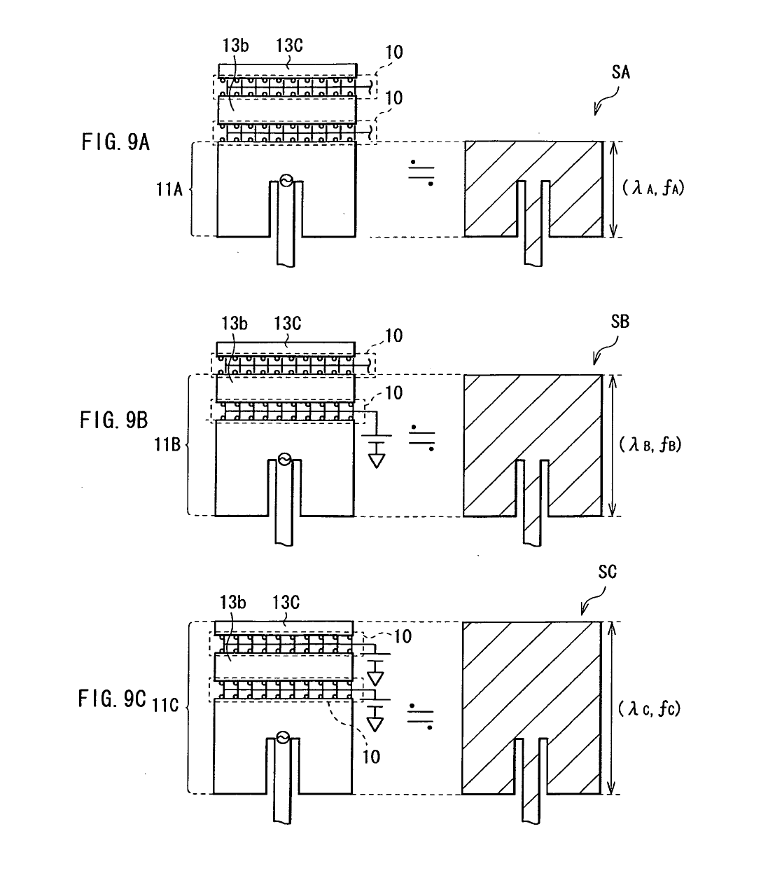

In this modified example, the three metal patterns 13a to 13c are disposed with the contact-point groups 10 sandwiched therebetween, and these contact-point groups 10 each serve to control the electrical coupling between the metal patterns 13a and 13b, and between the metal patterns 13b and 13c. As shown in FIG. 9A, when these metal patterns are all electrically insulated from one another, the electromagnetic waves are radiated from the radiation section 11A at the frequency f_{A} corresponding to the electrical length λ_{A} thereof. On the other hand, as shown in FIG. 9B, when the metal patterns 13a and 13b are electrically conducting by the drive section 20A driving the corresponding contact-point group 10, the electromagnetic waves are radiated from the radiation section 11B at the frequency f_{B} corresponding to the electrical length λ_{B} thereof. Moreover, as shown in FIG. 9C, when the metal patterns 13a and 13b are electrically conducting to each other by the drive section 20A driving the corresponding contact-point group 10, and also when the metal patterns 13b and 13c are electrically conducting to each other by the drive section 20B driving the corresponding contact-point group 10, the electromagnetic waves are radiated from the radiation section 11C at the frequency f_{C} corresponding to the electrical length λ_{C} thereof. As such, in this modified example, the electromagnetic waves that are to be radiated are of the frequencies f_{A}, f_{B}, and f_{C}, and frequencies that are integral multiples of the frequencies f_{A}, f_{B}, and f_{C}, i.e., frequencies f_{A}, 2f_{A}, 3f_{A}, and others, f_{B}, 2f_{B}, 3f_{B}, and others, and frequencies f_{C}, 2f_{C}, 3f_{C}, and others. In other words, the frequency switching can be performed based on three values of frequency, i.e., f_{A}, f_{B}, and f_{C}.

As such, the number of the metal patterns disposed with space from one another on the dielectric layer is not surely restricted to two as described in the first embodiment above, and may be three as in this modified example or may be four or more. In any case, the effects similar to those in the first embodiment described above can be achieved as long as the contact-point group is sandwiched between the metal patterns, and the drive section is provided for mechanical driving of each of the contact-point groups. In this modified example, such effects by the mechanical driving of the contact-point groups and the parallel arrangement of the contact-point pairs become more significant because the switches for use are increased in number as the metal patterns are increased in number, and as the range of frequencies available for switching becomes wider.

Moreover, when the number of the metal patterns provided in this modified example is three or more, it means that the number of the contact-point groups 10 is two or more. In such a case, driving of the contact-point groups 10 may be started one after another from any of those located on the side of the feeding point 12 for changing the state from OFF to ON. Such a procedure of driving is applicable also to embodiments and modified examples that will be described below.

### Second Embodiment

FIG. 10 is a diagram showing the schematic configuration of a reconfigurable antenna 3 in a second embodiment of the invention. Similarly to the reconfigurable antenna 1 in the first embodiment described above, this reconfigurable antenna 3 is a patch antenna that is capable of frequency switching among a plurality of patterns, and the contact-point group 10 is sandwiched between each two of a plurality of metal patterns 15a to 15c disposed with space from each other. These contact-point groups 10 are each coupled to the drive section via the push rod 30, and are changed in state between in-contact and no-contact by mechanical driving thereof. Note here that any component similar to that in the first embodiment described above is provided with the same reference numeral, and is not described again if appropriate.

However, unlike the reconfigurable antenna 1 in the first embodiment described above, the metal patterns 15a to 15c in the reconfigurable antenna 3 in the second embodiment are two-dimensionally disposed in two directions, i.e., a direction d1 along the feeding direction E, and a direction d2 orthogonal to the feeding direction E. To be specific, along the direction d1, the metal patterns 15a to 15c are disposed in order of 15a, 15b, and 15c from the side of the feeding point 12, and along the direction d2, the metal pattern 15a is disposed in line with another, the metal pattern 15b is disposed in line with two others, and the metal pattern 15c is disposed in line with three others. In this example, such groups of the metal patterns 15a to 15c are respectively made electrically conducting all at once. In other words, the electrical coupling of the metal patterns is controlled on the basis of their groups aligned along the direction d2. In FIG. 10, for convenience, the metal patterns 15a to 15c are each denoted by any of “A” to “C” depending on to which group it belongs.

In the space between any two of these metal patterns 15a to 15c, the contact-point group 10 is provided. However, every space does not include the contact-point group 10 but the space between any two metal patterns adjacent to each other along the direction d1, i.e., metal patterns in different groups, and the space between any two metal patterns adjacent to each other along the direction d2, i.e., metal patterns in the same group.

The contact-point groups 10 are coupled to either any of drive sections 20A1 to 20C1 or any of drive sections 20A2 to 20C2 depending on along which direction d1 or d2. To be specific, the contact-point group 10 between the feeding point 12 and the metal pattern 15a is coupled to the drive section 20A1, the contact-point group 10 between the metal patterns 15a and 15b is coupled to the drive section 20B1, and the contact-point group 10 between the metal patterns 15b and 15c is coupled to the drive section 20C1. The contact-point group 10 between the two metal patterns 15a is coupled to the drive section 20A2, the contact-point group 10 between predetermined two of the three metal patterns 15b is coupled to the drive section 20B2, and the contact-point group 10 between predetermined two of the four metal patterns 15c is coupled to the drive section 20C2. The drive sections 20A1 to 20C1, and the drive sections 20A2 to 20C2 are each provided with the actuator 20a coupled to the push rod 30, and the drive circuit 20b for driving the actuator 20a similarly to the drive section 20 in the first embodiment described above.

In this embodiment, as described above, the metal patterns 15a to 15c are two-dimensionally disposed along the two directions, i.e., the direction d1 along the feeding direction E, and the direction d2 orthogonal to the feeding direction E. These metal patterns are mechanically controlled by the contact-point groups 10 in terms of their electrical coupling. With a patch antenna, the length of the plane shape thereof along the feeding direction E is a control factor for the frequency, and the length thereof orthogonal to the feeding direction E is a control factor for the band, i.e., antenna directivity. In other words, in this embodiment, the direction d1 is the basis for the frequency switching, and the direction d2 is the basis for the control of antenna directivity.

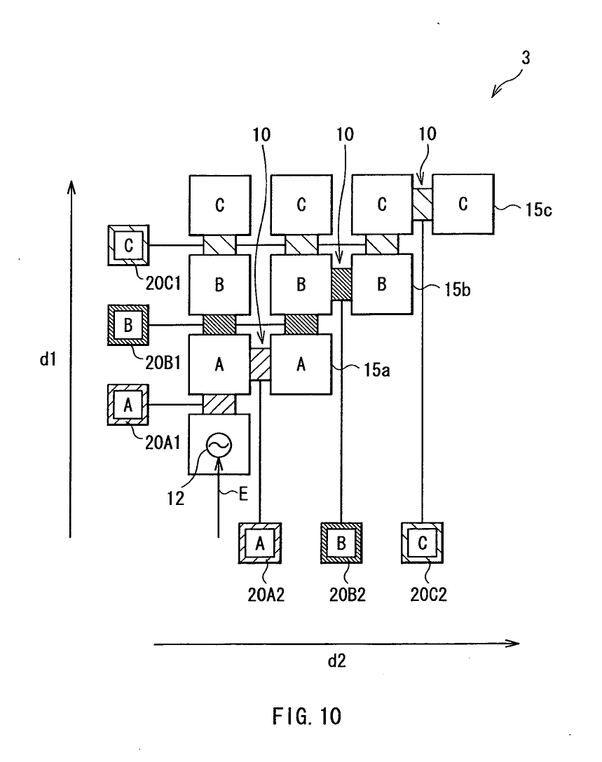

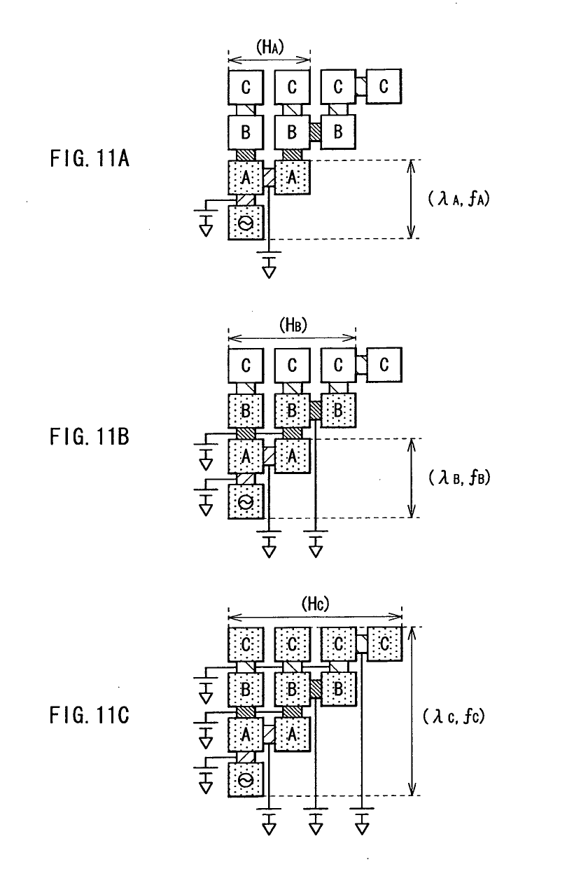

To be specific, when the drive sections 20A1 and 20A2 bring electrical conduction to the feeding point 12 and the metal pattern 15a, and to the two metal patterns 15a, the region from the feeding point 12 to the metal pattern 15a serves as the radiation section, and electromagnetic waves are radiated therefrom at the frequency f_{A} with the bandwidth of H_{A} (FIG. 11A). When the drive sections 20B1 and 20B2 bring electrical conduction to the metal patterns 15a and 15b, and to the three metal patterns 15b, the region from the feeding point 12 to the metal patterns 15b serves as the radiation section, and electromagnetic waves are radiated therefrom at the frequency f_{B} with the bandwidth of H_{B} (FIG. 11B). Moreover, when the drive sections 20C1 and 20C2 bring electrical conduction to the metal patterns 15b and 15c, and to the four metal patterns 15c, the whole region from the feeding point 12 to the metal patterns 15c serves as the radiation section, and electromagnetic waves are radiated therefrom at the frequency f_{C} with the bandwidth of H_{C} (FIG. 11C).

As described above, in the second embodiment, the effects similar to those achieved in the first embodiment described above can be achieved by using the contact-point groups 10 to mechanically control the electrical coupling between the metal patterns 15a to 15c, which are each disposed with space from another. Moreover, the resulting antenna can be controlled not only in terms of frequency but also in terms of directivity by the two-dimensional arrangement of the metal patterns 15a to 15c along the two directions of d1 and d2, and by the cumulative electrical conduction of the metal patterns 15a to 15c.

In the comparison examples 1 and 2, as described above, if the switches are disposed to the center portion and therearound of the region serving as the radiation section, the electromagnetic waves coming from the drive circuit or others adversely affect the radiation characteristics. In order to avoid such adverse influence, there is no way but to dispose the switches outside of the antenna. As a result, unlike the reconfigurable antenna in the embodiment, the resulting reconfigurable antenna cannot be controlled in both frequency and directivity by being changed in dimension two-dimensionally. On the other hand, with the reconfigurable antenna in the embodiment that can be arbitrarily controlled in dimension two-dimensionally, the antenna characteristics can be controlled with attention to details because any change in environment for transmission and reception is used as a basis to realize the optimum transmission-reception sensitivity.

Note that, in the second embodiment described above, the two-dimensionally-arranged metal patterns are controlled in terms of their electrical coupling on the group basis arranged along the direction d2. This is surely not restrictive, and alternatively, the electrical coupling among the metal patterns may be controlled on the group basis arranged along the direction d1, or may be controlled on the metal pattern basis.

### Third Embodiment

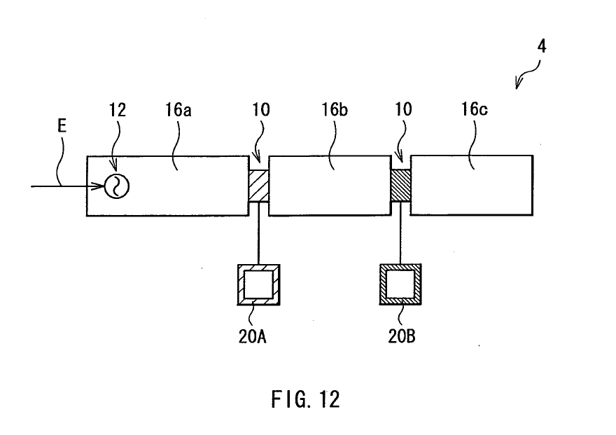

FIG. 12 is a diagram showing the schematic configuration of a reconfigurable antenna 4 in a third embodiment of the invention. The reconfigurable antenna 4 is capable of frequency switching among a plurality of patterns similarly to the reconfigurable antenna 1 in the first embodiment described above. In the reconfigurable antenna 4, three metal patterns 16a to 16c are each disposed with space from another along the feeding direction E, and the contact-point group 10 is provided between each two of these metal patterns 16a to 16c for mechanical driving respectively by the drive sections 20A and 20B. Note here that any component similar to that in the first embodiment described above is provided with the same reference numeral, and is not described twice if appropriate.

Note that the reconfigurable antenna 4 in this embodiment is a so-called monopole antenna, and the metal patterns 16a to 16c are formed on the surface of a cylindrical dielectric body extending along the feeding direction E. The reconfigurable antenna 4 is also provided with the drive sections 20A and 20B. The drive section 20A is in charge of driving the contact-point group 10 disposed between the metal patterns 16a and 16b, and the drive section 20B is in charge of driving the contact-point group 10 disposed between the metal patterns 16b and 16c.

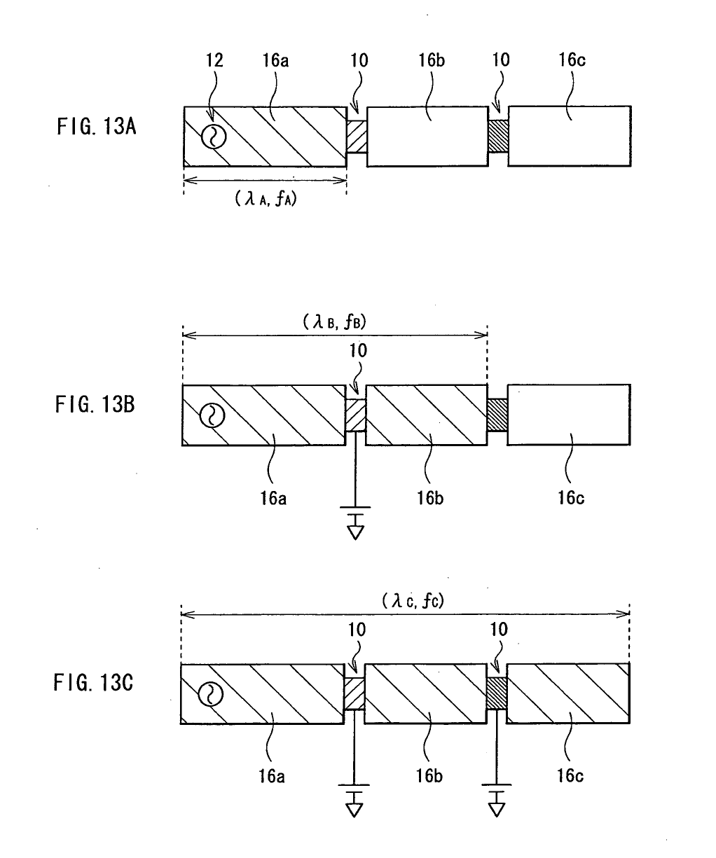

Also in this embodiment, the metal patterns 16a to 16c are each disposed with space from another along the feeding direction E as described above, and the electrical coupling among these metal patterns is mechanically controlled by the contact-point groups 10. In such a reconfigurable antenna, when the metal patterns 16a and 16b are electrically insulated from each other, the metal pattern 16a serves as the radiation section, and electromagnetic waves are radiated therefrom at the base frequency of f_{A} (FIG. 13A). On the other hand, when the drive section 20A brings electrical conduction to the metal patterns 16a and 16b, the region across the metal patterns, i.e., region from the metal pattern 16a to the metal pattern 16b, serves as the radiation section, and electromagnetic waves coming therefrom are at the base frequency of f_{B} (FIG. 13B). Moreover, when the drive section 20B brings electrical conduction to the metal patterns 16b and 16c, the region across the metal patterns, i.e., region from the metal pattern 16a to the metal pattern 16c, serves as the radiation section, and electromagnetic waves are radiated therefrom at the base frequency of f_{C} (FIG. 13C). With such a configuration, the effects similar to those achieved in the first embodiment described above can be achieved. Herein, such a monopole antenna is surely not the only option, and a so-called dipole antenna is also a possibility for application.

### Fourth Embodiment

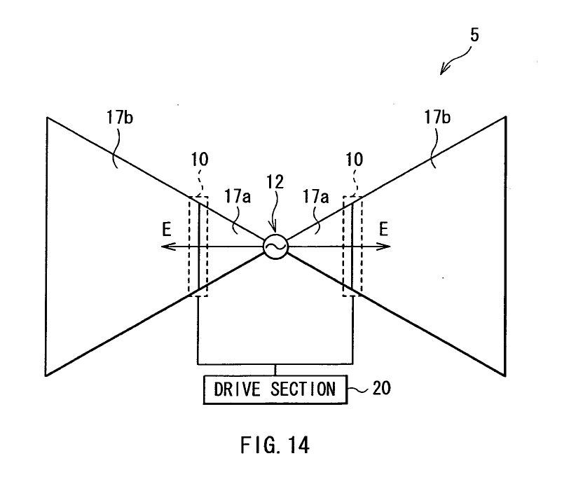

FIG. 14 is a diagram showing the schematic configuration of a reconfigurable antenna 5 in a fourth embodiment of the invention. The reconfigurable antenna 5 is a patch antenna capable of frequency switching among a plurality of patterns similarly to the reconfigurable antenna 1 in the first embodiment described above. In the reconfigurable antenna 5, two metal patterns 17a and 17b are each disposed with space from another along the feeding direction E, and the contact-point group 10 is provided therebetween for mechanical driving by the drive section 20. Note here that any component similar to that in the first embodiment described above is provided with the same reference numeral, and is not described twice if appropriate.

However, unlike the reconfigurable antenna 1 in the first embodiment described above, the reconfigurable antenna 5 in this embodiment is a so-called bowtie antenna, and is symmetrical about the feeding point 12. To be symmetrical about the feeding point 12 as such, the reconfigurable antenna 5 is provided with a pair of metal patterns 17a, and a pair of metal patterns 17b, for example. The metal patterns 17a are each shaped like a triangle in planar view, for example, and are each so disposed that the vertex of the triangle is directed toward the feeding point 12. The metal patterns 17b are each shaped like a trapezoid in planar view, for example, and are each so disposed that the upper base of the trapezoid opposes the bottom of the corresponding metal pattern 17a shaped like a triangle.

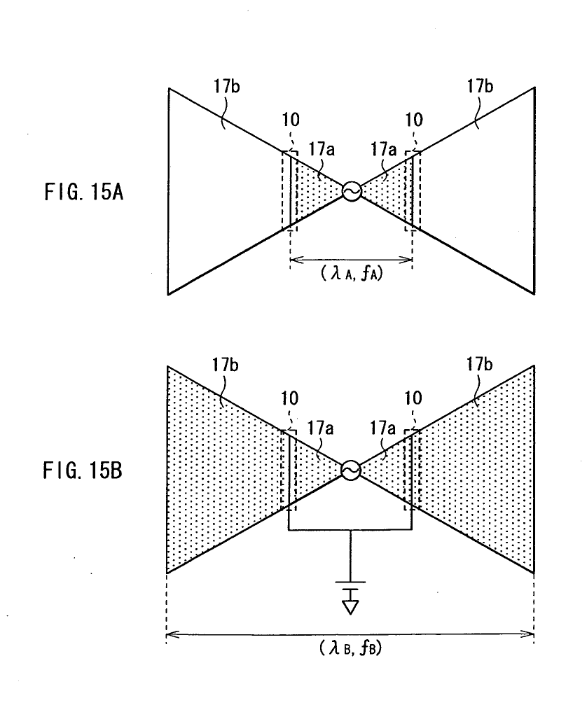

Also in the embodiment, the metal patterns 17a and 17b are each disposed with space from another along the feeding direction E, and the electrical coupling between these metal patterns 17a and 17b is mechanically controlled by the contact-point groups 10. In such a reconfigurable antenna, when the metal patterns 17a and 17b are electrically insulated from each other, only the metal patterns 17a in a pair serve as the radiation section, and electromagnetic waves are radiated therefrom at the base frequency of f_{A} (FIG. 15A). On the other hand, when the drive section 20 brings electrical conduction to the metal patterns 17a and 17b, the region across the metal patterns, i.e., region from the metal pattern 17a to the metal pattern 17b, serves as the radiation section, and electromagnetic waves are radiated therefrom at the base frequency of f_{B} (FIG. 15B). In other words, the frequency switching can be performed based on two values of frequency, i.e., f_{A} and f_{B}. As such, the effects similar to those achieved in the first embodiment described above can be achieved.

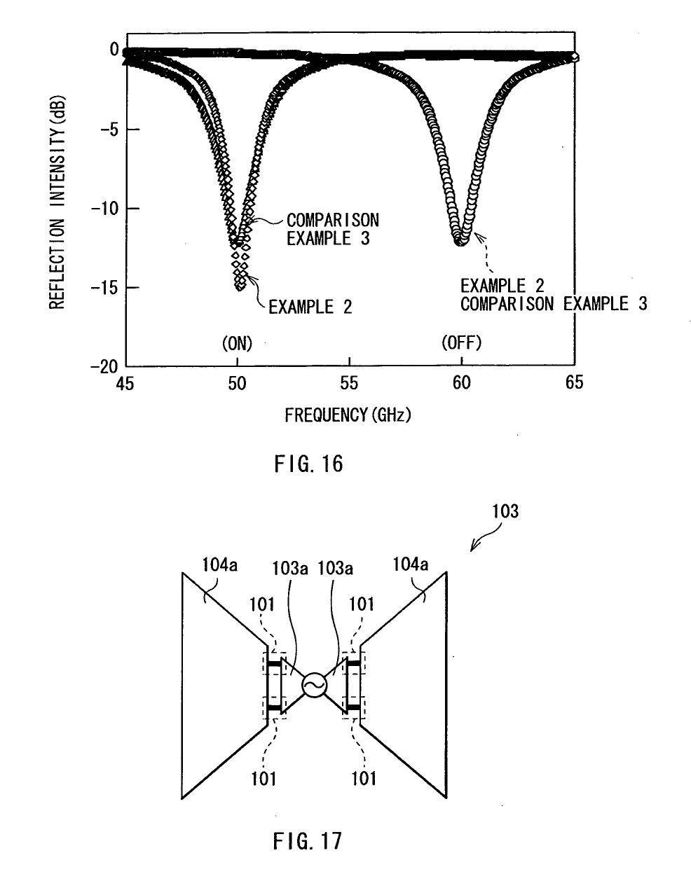

As an example of the fourth embodiment, i.e., example 2, the reflection intensity (dB) with respect to the frequency (GHz) of the reconfigurable antenna 5 is calculated using an electromagnetic simulator. FIG. 16 shows the calculation result. Note that the characteristics indicated by a broken arrow are those of the radiation section (electrical length λ_{A}, and frequency f_{A}) when the metal patterns 17a and 17b are electrically insulated from each other, i.e., in the OFF state. The characteristics indicated by a solid arrow are those of the radiation section (electrical length λ_{B}, and frequency f_{B}) when the metal patterns 17a and 17b are electrically conducting, i.e., in the ON state. Herein, in the OFF state, settings are made as λ_{A}=1.1, and λ_{B}=1.5 in the ON state. As a comparison example in this example 2, i.e., comparison example 3, such a calculation of reflection intensity with respect to the frequency is performed also to a reconfigurable antenna 103 as shown in FIG. 17. Herein, similarly to the reconfigurable antenna in the example 2, the reconfigurable antenna 103 in the comparison example 3 is provided with a pair of metal patterns 103a, and a pair of metal patterns 104a in such a manner as to be symmetrical about the feeding point. Herein, the switch 101 is disposed only at each end of the space between the metal patterns 103a and 103b.

With the calculation results in both of the example 2 and the comparison example 3, the resonance frequency is observed at 60 GHz in the OFF state (electrical length λ_{A}=1.1), and in the ON state (electrical length λ_{B}=1.5), the resonance occurs at 50 GHz. These results tell that both the example 2 and the comparison example 3 implement the reconfigurable antenna of including the two values of base frequency, i.e., 50 GHz and 60 GHz. Note here that, in the ON state, the reflection intensity in the example 2 shows the peak higher about by 3 dB than that in the comparison example 3. This indicates that the reconfigurable antenna in the example 2 has a higher gain and is excellent in directivity compared with the antenna in the comparison example 3. In other words, this tells that the radiation characteristics are to be improved with the configuration of including a plurality of contact-point pairs 10a each disposed in parallel, and by mechanically driving those contact-point pairs 10a.

### Modified Example 2

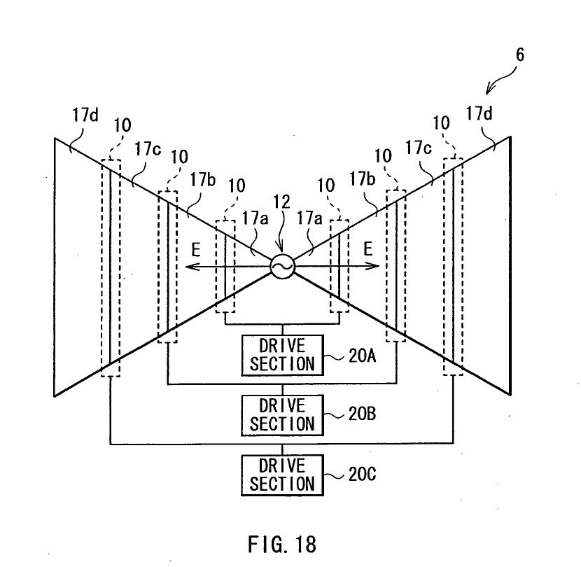

FIG. 18 is a diagram showing the schematic configuration of a reconfigurable antenna 6 in a modified example of the fourth embodiment described above, i.e., modified example 2. The reconfigurable antenna 6 is a bowtie antenna capable of frequency switching among a plurality of patterns similarly to the reconfigurable antenna 5 described above. In the reconfigurable antenna 6, a plurality of metal patterns are each disposed with space from another along the feeding direction E, and the contact-point group 10 is provided between each two metal patterns for mechanical driving by the drive sections. Such a plurality of metal patterns is disposed to be symmetrical about the feeding point 12. Note here that any component similar to that in the first and fourth embodiments described above is provided with the same reference numeral, and is not described twice if appropriate.

However, unlike the reconfigurable antenna 5 described above, the reconfigurable antenna 6 in this modified example is provided with four metal patterns 17a to 17d in total. The metal patterns 17c and 17d are each shaped like a trapezoid in planar view similarly to the metal pattern 17b, and are so disposed that the bottoms of the trapezoids are opposing each other, for example. In the reconfigurable antenna 6, the drive section 20A drives the contact-point group 10 between the metal patterns 17a and 17b, the drive section 20B drives the contact-point group 10 between the metal patterns 17b and 17c, and the drive section 20C drives the contact-point group 10 between the metal patterns 17c and 17d.

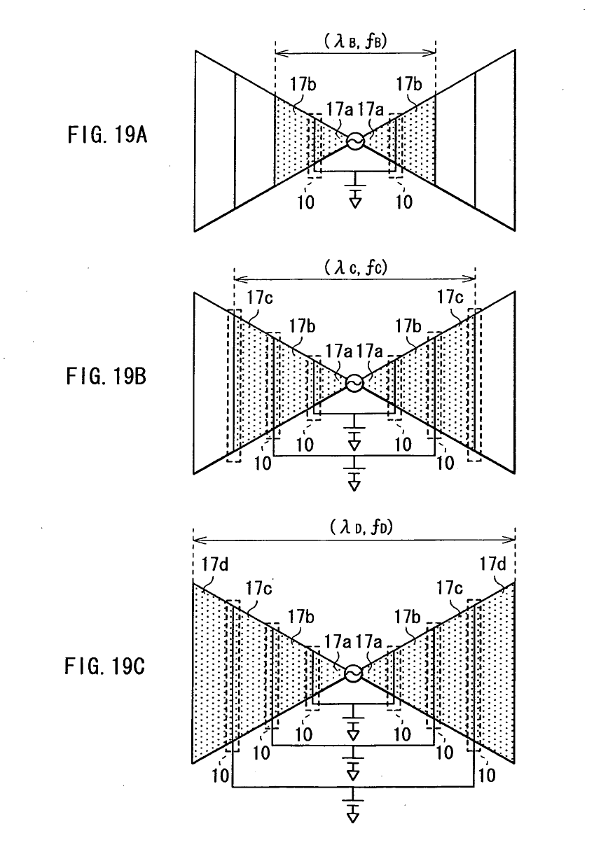

Also in this modified example, the metal patterns 17a to 17d are each disposed with space from another along the feeding direction E as described above, and the electrical coupling between these metal patterns is mechanically controlled by the contact-point groups 10. In such a reconfigurable antenna, when the metal patterns 17a and 17b are electrically insulated from each other, only the metal patterns 17a in a pair serve as the radiation section, and electromagnetic waves are radiated therefrom at the base frequency of f_{A} (not shown). On the other hand, when the drive section 20A brings electrical conduction to the metal patterns 17a and 17b, the region across the metal patterns, i.e., region from the metal pattern 17a to the metal pattern 17b, serves as the radiation section, and electromagnetic waves are radiated therefrom at the base frequency of f_{B} (FIG. 19A). Moreover, when the drive section 20B brings electrical conduction to the metal patterns 17b and 17c, the region across the metal patterns, i.e., region from the metal pattern 17a to the metal pattern 17c, serves as the radiation section, and electromagnetic waves are radiated therefrom at the base frequency of f_{C} (FIG. 19B). Moreover, when the drive section 20C brings electrical conduction to the metal patterns 17c and 17d, the region across the metal patterns, i.e., region from the metal pattern 17a to the metal pattern 17d, serves as the radiation section, and electromagnetic waves are radiated therefrom at the base frequency of f_{D} (FIG. 19C). In other words, the frequency switching can be performed based on four values of frequency, i.e., f_{A} to f_{D}.

As such, the number of the metal patterns is not surely restricted to two as described in the fourth embodiment above, and may be four as in this modified example or may be three, or five or more. In any case, the effects similar to those in the first to fourth embodiments described above can be achieved as long as the contact-point group is sandwiched between each two of the metal patterns, and the drive section is provided for mechanical driving of each of the contact-point groups.

### Fifth Embodiment

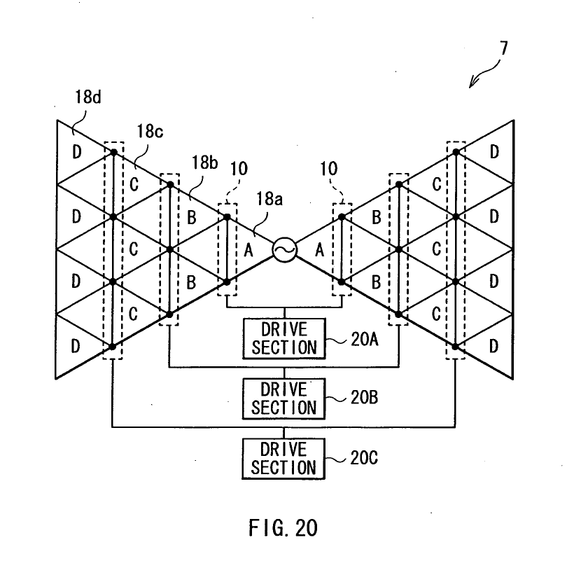

FIG. 20 is a diagram showing the schematic configuration of a reconfigurable antenna 7 in a fifth embodiment of the invention. The reconfigurable antenna 7 belongs to the category of bowtie antennas that are capable of frequency switching among a plurality of patterns similarly to the reconfigurable antenna 5 in the fourth embodiment described above. In the reconfigurable antenna 7, a plurality of metal patterns 18a to 18d are each disposed with space from another, and the contact-point group 10 is provided between each two metal patterns for mechanical driving by drive sections. These metal patterns 18a to 18d are disposed so as to be symmetrical about the feeding point 12. Note here that any component similar to that in the first and fourth embodiments described above is provided with the same reference numeral, and is not described twice if appropriate.

However, unlike the reconfigurable antenna 5 in the fourth embodiment described above, in the reconfigurable antenna 7 in this embodiment, the metal patterns 18a to 18d are all shaped like a triangle in planar view, and are disposed so as to be increased in number by degrees from the side of the feeding point 12 along the feeding direction E. To be specific, the metal patterns 18a to 18d are arranged in four lines in order from the side of the feeding point 12, i.e., the first line includes a piece of metal pattern 18a, the second line includes two pieces of metal patterns 18b, the third line includes three pieces of metal patterns 18c, and the fourth line includes four piece of metal patterns 18d. In other words, the nth line from the side of the feeding point 12 (where n is an integer being 1 or larger, and in this example, n is 4 or smaller) includes n pieces of metal patterns.

In these lines of the metal patterns 18a to 18d, the metal patterns 18a to 18d are aligned in the same direction, i.e., the vertexes of the triangles are all directed toward the feeding point 12, and are so disposed that the vertexes of one triangle are in close vicinity to those of other triangles. In other words, the three sides of each three of the metal patterns 18a to 18d form space also in the triangular shape. The metal patterns 18a to 18d in a regular arrangement as such are provided to be symmetrical about the feeding point 12, and are in the so-called fractal shape as a whole. Note that, in FIG. 20, for convenience, the metal patterns 18a to 18d are respectively denoted by “A” to “D”.

Between such metal patterns 18a to 18d, the contact-point group 10 is disposed between the vertexes of each two triangles, and are driven on the line basis. To be specific, the contact-point group 10 between the metal patterns 18a and 18b is driven by the drive section 20A, the contact-point group 10 between the metal patterns 18b and 18c is driven by the drive section 20B, and the contact-point group 10 between the metal patterns 18c and 18d is driven by the drive section 20C.

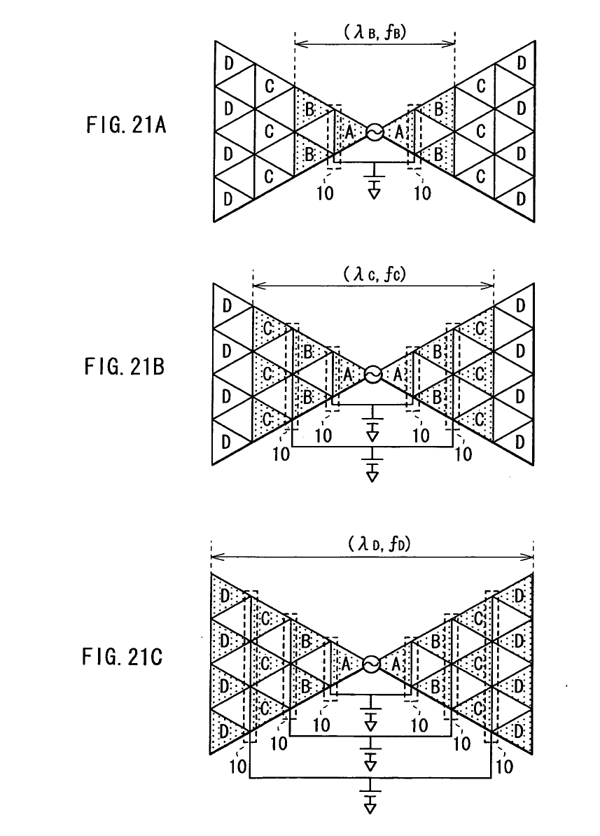

In this embodiment, the metal patterns 18a to 18d are each disposed with space from another in a predetermined arrangement, and the electrical coupling between these metal patterns 18a to 18d is mechanically controlled by these contact-point groups 10. In such a reconfigurable antenna, when the metal patterns 18a and 18b are electrically insulated from each other, only the metal patterns 18a in a pair serve as the radiation section, and electromagnetic waves are radiated therefrom at the base frequency of f_{A} (not shown). On the other hand, when the drive section 20A brings electrical conduction to the metal patterns 18a and 18b, the region across the metal patterns, i.e., region from the metal pattern 18a to the metal pattern 18b, serves as the radiation section which radiates electromagnetic waves at the base frequency of f_{B} (FIG. 21A). Moreover, when the drive section 20B brings electrical conduction to the metal patterns 18b and 18c, the region across the metal patterns, i.e., region from the metal pattern 18a to the metal pattern 18c, serves as the radiation section which radiates electromagnetic waves at the base frequency of f_{C} (FIG. 21B). When the drive section 20C brings electrical conduction to the metal patterns 18c and 18d, the region across the metal patterns, i.e., region from the metal pattern 18a to the metal pattern 18d, serves as the radiation section which radiates electromagnetic waves at the base frequency of f_{D} (FIG. 21C). In other words, the frequency switching can be performed based on four values of frequency, i.e., f_{A} to f_{D}. As such, the effects similar to those achieved in the first embodiment described above can be achieved.

With the metal patterns 18a to 18d arranged as such in the fractal shape, the resulting radiation sections can be all similar in shape at the time of frequency switching. This favorably leads to the similar frequency responses in the range of frequencies available for switching. To be specific, the ratio between the center frequency fr and the band width thereof δf, i.e., δf/fr, can remain the same. With a general reconfigurable antenna, the frequency response shows a large change by the frequency switching, but with the reconfigurable antenna 7 in this embodiment, such a change of frequency response is prevented with ease.

Furthermore, with such a layout of the switches 101 as described in the comparison examples 1 and 2, the metal patterns cannot be arranged in a plurality of lines, especially in three or more lines as in the embodiment. This is because, with the reconfigurable antennas in the comparison examples 1 and 2, arranging the metal patterns in three or more lines means placing the switches 101 in the center portion and therearound of the radiation section, and this causes adverse influence to the radiation characteristics due to electromagnetic waves coming from the drive circuit as described above. On the other hand, in this embodiment, the contact-point groups 10 can be electrically insulated from the drive section, and be disposed with space therefrom. This accordingly allows the placement of the contact-point groups 10 in the center portion and therearound of the region serving as the radiation section without reducing the radiation characteristics. To be specific, the contact-point group 10 can be disposed at an inner position between the metal patterns 18b and 18c, and at two inner positions between the metal patterns 18c and 18d. As such, with the advantages of the fractal shape offering the satisfactory radiation characteristics, the metal patterns can be arranged in a larger number of lines, and the range of frequencies available for switching can become wider.

While the invention has been described in detail with the embodiments, the foregoing description is in all aspects illustrative and not restrictive. It is understood that numerous other modifications and variations can be devised. For example, the transmission/reception element in the aspect of the invention is exemplified by a reconfigurable antenna that is capable of frequency switching, but alternatively, a reconfigurable antenna that can be controlled in directivity is also possible using the principles of the invention, i.e., change the state of metal patterns by mechanical control. As an example, changing the symmetry of the antenna means controlling the antenna directivity, more specifically, controlling the direction of radiation and the spreading of radiation surface. Alternatively, the antenna can be controlled in terms of sensitivity not by changing the frequency and antenna directivity but based on the effective area of the antenna. This can be realized by controlling the number of antennas effective for use in a patch antenna in which metal patterns are arranged like an array, for example.

The present application contains subject matter related to that disclosed in Japanese Priority Patent Application JP 2010-020371 filed in the Japan Patent Office on Feb. 1, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A transmission/reception element comprising:
a plurality of metal layers each disposed with space from another; and
a switch for controlling electrical coupling between the metal layers, wherein the switch includes
a contact-point group including a plurality of contact-point pairs each disposed in parallel between each two of the metal layers, and
a drive section mechanically driving the contact-point group for state change of each of the contact-point pairs between in-contact and no-contact.

2. The transmission/reception element according to claim 1, wherein
the drive section is electrically insulated from the contact-point group.

3. The transmission/reception element according to claim 1, wherein
the drive section is provided to a region in a plane that is shared with the contact-point group, and to a region outside of a region where the metal layers are disposed.

4. The transmission/reception element according to claim 1, further comprising:
a movable member that is coupled to the drive section at one end, is provided with a plurality of bars at a remaining end side, and is allowed to slide in a direction along which the contact-point pairs are arranged, wherein
the contact-point pairs are each provided with a fixed contact point provided to a side of the metal layers, and a movable contact point provided to each of the bars of the movable member.

5. The transmission/reception element according to claim 4, wherein
the movable member and the bars are covered by a metal film in a region corresponding to the contact-point group.

6. The transmission/reception element according to claim 1, wherein
the metal layers and the contact-point group are provided to one surface side of a dielectric layer, and a remaining surface side of the dielectric layer functions as a grounded antenna.

7. The transmission/reception element according to claim 6, wherein
the metal layers are each made flat.

8. The transmission/reception element according to claim 7, wherein
the metal layers are each in a rectangular shape in planar view,
the metal layers are disposed along a feeding direction with sides of the rectangles opposing each other, and
the contact-point group is provided between the opposing sides.

9. The transmission/reception element according to claim 7, wherein
the metal layers are arranged two-dimensionally along a direction along the feeding direction, and a direction orthogonal thereto.

10. The transmission/reception element according to claim 7, wherein
the metal layers are symmetrical about a feeding point.

11. The transmission/reception element according to claim 10, wherein
the metal layers are all in a substantially same shape like a triangle in planar view, and are aligned in a same direction in a plurality of lines,
n piece(s) of the metal layers are disposed in an nth line (where n is an integer of 1 or larger) from a side of the feeding point, and
the contact-point group is disposed between vertexes of each two of the metal layers.

12. The transmission/reception element according to claim 6, wherein
the metal layers are each in a cylindrical shape.

13. The transmission/reception element according to claim 1, wherein
the drive section collectively drives the contact-point pairs in the contact-point group.

14. The transmission/reception element according to claim 1, wherein
the drive section includes a MEMS actuator.

15. The transmission/reception element according to claim 14, wherein
the MEMS actuator is an electrostatic MEMS actuator operated by lateral driving.
